(19) United States
(12) Patent Application Publication
(10) Pub. No.: US 2024/0351105 A1
(43) Pub. Date: Oct. 24, 2024

(54) AMBIENT TEMPERATURE SINTERABLE SILVER NANOALLOY INKS AND PASTES

(71) Applicant: The Research Foundation for the State University of New York, Albany, NY (US)

(72) Inventors: Chuan-Jian Zhong, Vestal, NY (US); Richard Robinson, Kettering, OH (US); Shan Wang, Tualatin, OR (US); Shan Yan, Medford, NY (US); Guojun Shang, Vestal, NY (US)

(21) Appl. No.: 18/630,630

(22) Filed: Apr. 9, 2024

Related U.S. Application Data
(60) Provisional application No. 63/460,162, filed on Apr. 18, 2023.

(51) Int. Cl. B22F 9/24; B22F 1/0545; B82Y 30/00; C09D 11/033; C09D 11/037

(52) U.S. Cl. CPC B22F 9/24; B22F 1/0545; B82Y 30/00; C09D 11/033; C09D 11/037; B22F 2201/02; B22F 2301/10; B22F 2301/255; B22F 2304/054

(57) ABSTRACT

Nanoparticles with a bimetallic silver-copper (AgCu) alloy composition with ambient (room temperature) sintering properties. The bimetallic alloy is formulated with nanoparticles which are contained in a stable nanoink or nanopaste. The nanoink or nanopaste can be printed on paper and other substrates and be sintered under room temperatures. A method of creating the AgCu composition is also provided.

### CROSS-REFERENCE TO RELATED APPLICATION

This application claims the benefit of U.S. Provisional Patent Application Ser. No. 63/460,162, filed on Apr. 18, 2023, the entirety of which is hereby incorporated herein by this reference.

### STATEMENT REGARDING FEDERALLY SPONSORED RESEARCH

This invention was made with government support under Grant Award Numbers CHE2102482 and IIP1923323, awarded by the National Science Foundation. The government has certain rights in the invention.

### BACKGROUND OF THE INVENTION

### 1. Field of the Invention

The present invention generally relates to nanoalloy materials. More particularly, the present invention relates to bimetallic silver-copper alloy nanoinks with room-temperature sintering properties.

### 2. Description of the Related Art

Printable inks and functional inks can provide specific properties, such as electrical conductivity, to a substrate. Ink can be printable and not necessarily functional, and an ink which contains a material that provides a specific functionality may not necessarily be printable. Further, ink may be deposited or coated onto a substrate, such as paper, plastic, metal, or semiconductor material, and glass or plastic substrates.

Various nanomaterials can now be formulated into ink forms. Inks contain various filler materials, and by removing a small weight percentage of filler materials, this enables a small concentration of nanomaterials to be formulated within an ink. The incorporation of nanomaterials can bring a variety of properties to the ink itself, as well as affecting the physical manner in which the nanoink can be printed or deposited on a substrate. There is a growing demand for the production and manufacturing of nanoinks or nanopastes for a wide range of applications including medicine, environmental monitoring, sensors, catalysis, and electronics.

One of the fastest growing areas of nanoink applications is in printed electronics for sensors and solar cells. The technology development in these areas depends on scalable synthesis of various metal nanoparticles (NPs) with controllable sizes, compositions and sintering properties. In addition to a high surface area to volume ratio, the surface atoms of NPs experience a different chemical reactivity than the bulk counterparts, reflecting transitions from metallic to atomic properties, and leading to intriguing mechanical, magnetic, electrical, and biological properties. NPs synthesized with noble metals, such as gold, silver, and platinum, exhibit multifunctionality and tunable surface functionalization. Coinage metals such as gold, silver, and copper have a distinct localized surface plasmon resonance (LSPR), which have attracted interest in developing advanced sensors and electronics.

Silver has been at the forefront of nanoscale research in recent years because of its high electrical conductivity and enhanced surface plasmon resonance. In accordance with other noble metals, silver ink or paste is known for its stability, conductivity, and facile synthesis. One of the major drawbacks of the use of silver, however, is the high and volatile cost. Silver is much more expensive than other transition metals such as nickel and copper. The price of silver also fluctuates at a much more drastic monthly level compared to copper, making it more susceptible to market swings. While copper has advantages over silver and other noble metals in terms of cost, it faces serious challenges in stability.

In atmospheric conditions, copper has a high propensity to oxidize, making it more difficult to synthesize copper-based nanoparticles under ambient conditions. Certain actions can be taken to prevent rapid oxidation of copper, such as the addition of stabilizers or running synthesis under nitrogen and argon. These measures, however, can be costly and time-consuming, making the overall synthesis process for copper nanoparticles (CuNPs) less favorable than that of silver nanoparticles (AgNPs) despite the cost benefit. Therefore, there has been interest in alloying cooper and silver in NPs to address the issues of the high cost of silver and copper oxidation.

Alloying can change the properties from that of the monometallic NP forms. Bimetallic nanoalloys feature a random combination of the metals in alloy structures, whereas the core-shell structure develops an outer coating of one metal on the other. A key challenge to the synthesis of silver-copper alloy NPs is the ability to control size, composition, phase structure, and oxidation resistance.

Despite significant progress in the synthesis of bimetallic silver-copper NPs, the ability to control the bimetallic nanoclusters (NCs) and NPs remains a challenge. Often, the presence of NCs make it difficult to separate NCs from NPs. The process of Ostwald Ripening can occur, in which larger particles grow at the expense of smaller particles. On the other hand, the process of Reverse Ostwald Ripening occurs when smaller particles break away from the NCs, which can lead to a bimodal distribution of NCs/NPs.

Different methods such as wet-chemical and physical methods have been demonstrated for the synthesis, but most of the methods require organic solvents and high temperature. The nanoparticles synthesized in aqueous solution or low temperatures often suffer from instability due to the propensity of aggregations. For applications of the NPs as nanoinks or nanopastes for printed conductive devices, most silver-based nanoparticles require relatively high temperatures (>70° C.) to sinter, which is problematic for devices involving temperature-sensitive substrates such as paper substrates. There has been little success in increasing the ability of near-room temperature sintering for silver-based nanoinks or nanopastes.

There has been some success in demonstrating that silver NPs and nanowires (NWs) exhibit room temperature sintering properties in the presence of electrolytic halide. For example, AgCu core-shell NPs synthesized in organic conditions were sintered at room temperature utilizing a reducing agent like hydrazine. In other extant methods, the room-temperature sintering involved galvanic displacement and subsequent electrolytic conditions.

What is therefore needed in this technology is a scalable synthesis of silver-copper (AgCu) alloy NPs and nanoinks with room-temperature sintering capability. The nanoinks/pastes prepared from the AgCu NPs with controllable composition should be stable and easily sinterable on paper or other substrates at ambient temperatures without any subsequent chemical treatments. Such technology would be advantageous in fabricating conductive traces or devices for applications in sensors, solar cells and wearable electronics. It is thus to address the above problems with the prior art and provide this new technology that the present invention is primarily directed.

### BRIEF SUMMARY OF THE INVENTION

Briefly described, the present invention provides a scalable wet-chemical synthesis route for AgCu alloy NPs with controllable bimetallic compositions and room-temperature sintering capability. The bimetallic alloy nanoinks presented herein are stable in controlled ink formulations and sinterable under room temperatures. In addition to composition dependence, the dependence of the sintering can also be based on the humidity above the printed nanoink films. The nanoparticles are formulated as inks/pastes for printable applications with a high degree of conductivity. The present bimetallic alloy nanoinks, depending on the composition, display a relatively high degree of stability and scalability. The AgCu alloy nanoparticles of the present invention can be formulated into conductive inks and pastes, and the room temperature sintering capabilities has application in a wide range of technologies, such as in printable electronics and wearable sensors.

In one embodiment, the invention provides a bimetallic, sinterable AgCu alloy composition including AgCu nanoparticles in a molecular structure in a range between Ag₁₀Cu₉₀ and Ag₉₅Cu₅, wherein the AgCu nanoparticles further in a size range between 4.5 nm to 11.5 nm, and ethylene glycol, such that the AgCu nanoparticles comprise, at least, 25% by weight of the composition. The composition can further include deionized water and ethanol and be further comprised of 30% by weight of AgCu nanoparticles, 30% by weight of ethylene glycol, 30% by weight of deionized water, and 10% by weight of ethanol. In this embodiment, the composition can comprise a nanoink. The AgCu nanoparticles are optimally in a molecular structure of Ag₂₃Cu₇₇.

The composition can further include hydroxyethyl cellulose and be further comprised of 30% by weight of AgCu nanoparticles, 50% of a solution of 5% aqueous hydroxyethyl cellulose, and 20% weight of ethylene glycol. In such embodiment, the composition comprises a nanopaste.

In one embodiment, the invention provides a method of making a bimetallic, sinterable AgCu alloy composition, including the steps of providing a container under a constant flow of nitrogen, purging deionized water in the container with nitrogen for a predetermined duration, adding copper (II) nitrate trihydrate to the deionized water, adding sodium citrate to the container, adding silver nitrate to the container, adding sodium borohydride to the container, washing the solution in the container with a capping agent, centrifuging the solution, decanting the solution, and resuspending the remaining powder after the decanting in deionized water. The decanting results in the powder comprising AgCu nanoparticles in a molecular structure in a range between Ag₁₀Cu₉₀ and Ag₉₅Cu₅, wherein the AgCu nanoparticles further in a size range between 4.5 nm to 11.5 nm.

The method can include adding ethylene glycol with the AgCu nanoparticles in deionized water such that the AgCu nanoparticles comprise, at least, 25% by weight of the solution. Alternately, the method can include adding copper (II) nitrate trihydrate to the deionized water is adding copper (II) nitrate trihydrate at (Cu(NO3)2·3H2O, 99%), adding silver nitrate to the container is adding silver nitrate at (AgNO3, 99.998%), adding sodium borohydride to the container is adding sodium borohydride powder at (NaBH4, ≥98%), and washing the solution in the container with a capping agent is washing the solution with trisodium citrate dihydrate at (Na3C6H5Na3O7·2H2O, ≥99.0).

Further, the method creates a nanoink by further mixing a solution by adding 30% by weight of AgCu nanoparticles, 30% by weight of ethylene glycol, 30% by weight of deionized water, and 10% by weight of ethanol, and ultrasonicating the solution in an ice bath for at least 3 cycles of 15 minutes each. Alternately, the method can include creating a nanopaste by creating a composition by adding 30% by weight of AgCu nanoparticles, 50% of a solution of 5% aqueous hydroxyethyl cellulose, and 20% weight of ethylene glycol, and ultrasonicating the composition for 1 hour-15 minute cycles in an ice water bath.

In one embodiment, the method is purging 40 mL of deionized water at 18.2 MΩ with nitrogen for 10 minutes under stirring at 700 RPM, adding 0.100 ml of Cu(NO3)2 at 1 M to the deionized water, adding 0.100 mL of silver nitrate at 1 M, adding sodium borohydride powder at a concentration of NaBH₄, ≥98% at 0.25 M, and washing the solution in the container with 0.100 mL of trisodium citrate dihydrate at 0.88 M. The resuspending of the remaining powder after the decanting in deionized water a powder comprised of AgCu nanoparticles results in a solution of the AgCu nanoparticles of about 7.1 nm in diameter, and which contains about 1014 AgCu nanoparticles/mL.

The invention also provides a method of making a printed circuit with an AgCu alloy composition on paper substrates, by preparing a bimetallic, sinterable AgCu alloy composition comprised of AgCu nanoparticles in a molecular structure in a range between Ag₁₀Cu₉₀ and Ag₉₅Cu₅, wherein the AgCu nanoparticles further in a size range between 4.5 nm to 11.5 nm, mixing the AgCu alloy composition with, at least, ethylene glycol, wherein the AgCu nanoparticles comprise, at least, 25% by weight of the composition, depositing the mixture on a paper substrate, and sintering the deposited mixture at an ambient temperature.

In one embodiment, the composition used is comprised of 30% by weight of AgCu nanoparticles, 30% by weight of ethylene glycol, 30% by weight of deionized water, and 10% by weight of ethanol, and depositing the mixture is printing a nanoink on a paper substrate. In a further embodiment, the composition is further comprised of hydroxyethyl cellulose, 30% by weight of AgCu nanoparticles, 50% of a solution of 5% aqueous hydroxyethyl cellulose, and 20% weight of ethylene glycol, and depositing the mixture is layering a nanopaste on a paper substrate.

In one embodiment, depositing the mixture on the paper substrate is done at thickness between 10 μm to 48 μm. Furthermore, the sintering can be water vapor induced sintering.

The present invention therefore gives an industrial advantage by providing a printable AgCu alloy that is sinterable under ambient temperature. The present invention has industrial applicability in a wide range of technologies, such as in printable electronics, flexible circuit substrates, and wearable sensors. Other advantages of the present invention will be apparent to one of skill in the art after review of the following Specification, Drawings and Claims.

### BRIEF DESCRIPTION OF THE DRAWINGS

FIG. 1 is a graph illustrating the correlation between molar feed ratio of Ag and ICP-OES determined Ag composition in AgCu NPs.

FIG. 2 shows TEM images of AgCu NPs with insets of magnified areas, and the corresponding particle size distributions.

FIG. 3 illustrates graphs showing Dynamic Light Scattering plots of AgCu NPs of different compositions.

FIG. 4 illustrates graphs of XRD patterns for AgCu NPs with different compositions.

FIG. 5 illustrates graphs of UV-Vis spectra for AgCu NPs with different compositions.

FIG. 6A are pictures of conductive traces and interdigitated electrode arrays on photopaper substrate by screen printing of Ag₅₅Cu₄₅ nanoink, with an illustration of a device strain test with tensile and compressive strains.

FIG. 6B is a graph of the results of a strain test of a 33 mm×2 mm photopaper strip printed with a conductive Ag₅₅Cu₄₅ trace upon tensile and compressive strain.

FIG. 7A illustrates graphs of transient changes of the resistances measured following printing Ag₅₅Cu₄₅ (25% by weight) nanoink on the gap area defined by a silver trace on a HP Photo Paper under ambient condition.

FIG. 7B illustrates photos showing the photopaper substrate with conductive-silver traces with a 2-mm gap, and the electrical measurement setup.

FIG. 8A is an illustrative diagram of an instrument scheme illustrating a measurement setup.

FIG. 8B illustrates graphs of transient curves showing the changes of resistance of the nanoink-printed IME device with the film of (a) Ag₅₅Cu₄₅ (30% by weight), and (b) Ag₅₅Cu₄₅-HEC (30%-30% by weight).

FIG. 9 illustrates graphs of simulation results based on GT-Model for the sintering processes of Cu, Ag, and AgCu NPs.

FIG. 10 is a graph of DLS spectra for a solution of Ag₈₆Cu₁₄ nanoparticles.

FIG. 11 is a picture of a transmission electron microscope (TEM) image for an aqueous solution sample of Ag₅₀Cu₅₀ nanoparticles after drying on a carbon film under an ambient condition.

### DETAILED DESCRIPTION OF THE INVENTION

With reference to the figures in which like numerals represent like elements throughout the several views, the invention is composition and method of creating and using a bimetallic, AgCu alloy composition including AgCu nanoparticles, which is sinterable at ambient temperatures, such as room temperature (59° to 77° F./15° to 25° C.). In demonstrating the present invention, metal precursors to produce AgCu NPs were all purchased from Millipore-Sigma. Silver nitrate (AgNO_{3,} 99.998%), Copper (II) nitrate trihydrate (Cu(NO₃)₂·3H₂O, 99%), Trisodium citrate dihydrate (Na₃C₆H₅Na₃O₇·2H₂O, ≥99.0%) was used as the capping agent to prevent aggregation. The reducing agent of sodium borohydride powder (NaBH₄, ≥98%) was also required for each synthesis. Hydroxyethyl-cellulose was used as an additive to increase viscosity in nanopaste formulations. Each of the chemical precursors were purchased new and handled with care to avoid contamination.

Bimetallic AgCu nanoparticles (NPs) were synthesized at ambient temperatures using a wet-chemical reduction method by controlling the feeding ratios of the metal precursors. To carry out this synthesis under nitrogen, which prevents copper oxidation and nanoparticle aggregation, a Schlenk line was set up for the entirety of precursor additions. This line carried a constant flow of nitrogen through the whole system and continued for 1 hour after all precursors were added. In a round bottom flask, 40 mL deionized water (DI) at 18.2 MΩ was purged with nitrogen for 10 minutes under stirring at 700 RPM. After purging, 0.100 mL Cu(NO₃)₂ (1 M) was added to the water via micropipette. Next, a capping agent, 0.100 mL sodium citrate (0.88 M) was added.

The purpose of adding this capping agent directly after the copper was to help increase colloidal stability and decrease aggregation during synthesis. The next step required 0.100 mL AgNO₃ (1 M). Lastly, 0.800 mL of reducing agent, NaBH₄ (0.25 M), was added slowly in excess to the flask. The formation of the bimetallic NPs was evidenced by the color changes where the solution transitioned from light blue after addition of metal precursors and capping agent to dark brown upon addition of the reducing agent (FIG. S1). Assuming 100% yield, the resulting solution of the NPs (radius=7.1 nm) contains about 1014 NPs/mL The reducing agent was added last to maintain a higher degree of control over the nanoparticle production. The as-synthesized NPs were thoroughly washed of capping agent and centrifuged at 15,000 RPM for 45 minutes. The colorless supernatant was decanted, and the remaining powder was resuspended in DI water.

Nanoinks were formulated by mixing a solution with 30% by weight NPs, 30% by weight, ethylene glycol, 30% by weight DI water, and 10% by weight ethanol. The mixture was ultrasonicated in an ice bath for 3 cycles of 15 minutes. The mixture was then stored at 5° C. for later use. Nanopastes were formulated with 30% by weight NPs, 50% by weight of 5% hydroxyethyl cellulose_{(aq)}, and 20% by weight ethylene glycol. The mixture was then ultrasonicated for the 1-hour-15 minute cycles in an ice water bath, which was stored at 5° C. for later use.

Ultraviolet-Visible Spectroscopy (UV-Vis) was utilized to identify the SPR for various compositions of AgCu NPs. An Agilent 8543 UV-Vis spectrometer with a range of 200-1100 nm and both tungsten and deuterium lamps were used for analysis. A blank of DI water in a disposable cuvette was run before any sample measurements, and a base scan of 150.00 μL of synthesized solution sample was typically analyzed for each solution. Pure silver samples were analyzed with less than 125.00 μL, and Ag₂₃Cu₇₇ samples were analyzed with 250.00 μL.

Inductively Coupled Plasma-Optical Emission Spectroscopy (ICP-OES) was used to determine the elemental composition of the AgCu NPs. The samples were prepared with concentrated nitric acid and left to decompose the solutions for 1 hour. After the decomposition, the remaining nitric acid was boiled off. The metallic components left in solution after burning all the acid were mixed with DI water and left to cool for another 1 hour. Then, 10 mL of the metal-water mixture was pipetted and analyzed with the ICP-OES instrument.

Transmission Electron Microscopy (TEM) was used to capture images of the NP surfaces for identifications of NP size, shape, and structure. A JEOL JEM-ARM200F instrument was used and operated at 200 kV. X-Ray Diffraction (XRD) was performed with a Phillips X'pert PW 3040 MPD x-ray diffractometer that was used to collect XRD data for various compositions of AgCu NPs. The NPs were cleaned and stripped of capping agent, then concentrated and dispensed onto quartz crystal.

Dynamic Light Scattering (DLS) was also performed with a sample diluted 1:2 with DI water. DLS measurements were recorded using a Zetasizer Ultra (Malvern Panalytical Ltd, UK), fitted with a 10 mW 632.8 nm laser, with measurements performed using a Side Scatter with a 90° scattering angle. Zeta Potential measurements were made with samples diluted 1:2 with DI water. All measurements were recorded using a Zetasizer Ultra (Malvern Panalytical Ltd, UK), fitted with a 10 mW 632.8 nm laser, with measurements performed using a Side Scatter with a 90° scattering angle. Electrical Resistance Measurements of resistances were conducted using a BK Precision 393 Digital Multimeter with an IR USB connection for two-probe measurements. Sheet resistance was measured using a four-probe Digital Multimeter (Suzhou Jingge Electronic M-3).

AgCu NPs were synthesized via chemical reduction in aqueous solutions. Briefly, Cu(NO₃)₂ was added first to solution, and then capped with the sodium citrate, which produced a coordination complex. The formation of this coordination complex caused a color change from clear to blue. The capping agent also acted as a weak reducing agent to the Cu²⁺, which reduced the surface energy of the Cu²⁺ ions and prevented aggregation. The AgNO₃ was added directly after the capping agent, where it bound to the capped Cu-ligand complex. No color change was observed at this step. The chemical reducing agent, NaBH₄, was then added in excess to the solution. This method produced a solution of the AgCu NPs with excellent suspension, showing no indication of aggregation.

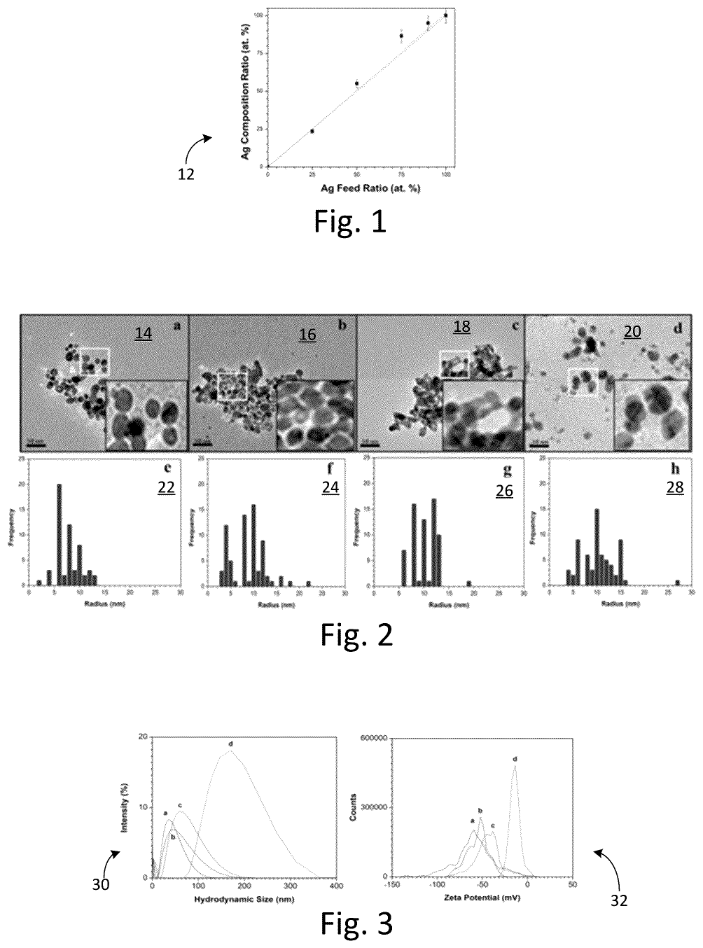

The bimetallic composition of the AgCu NPs is controlled by the feeding ratio of the metal precursors in terms of the moles of AgNO₃ and Cu(NO₃)₂ in the solution. The NP compositions were determined by ICP-OES. The molar feed percentages of Ag and Cu in the solution were compared to the Ag and Cu composition in the NPs that was determined by ICP. FIG. 1 is a graph illustrating the correlation between molar feed ratio of Ag and ICP-OES determined Ag composition in AgCu NPs (linear regression: Ag % (in NPs)=1.05 Ag % (feeding)+0.41) (The dashed line represents an ideal 1:1 relationship).

As shown by the plot of Ag % in the NPs vs. Ag % in the solution in FIG. 1, the slope of 1.05 is clearly indicative of a 1-to-1 relationship. Since the intercept of 0.4 is close to 0, the slope suggests that the Ag % in the NPs is slightly higher than that in the solution, especially in higher Ag % concentrations. This suggests a slightly higher favorability of Ag over Cu in the bimetallic AgCu NPs during the synthesis. This subtle difference can be explained by the difference of the redox potentials of Ag⁺ (0.800 V) and Cu²⁺ (0.342 V). The reduction potential for BH⁴⁻ is −1.240 V in basic solution and −0.481 V in acidic solution. Therefore, the reduction of Ag⁺ occurs more favorably than that of Cu²⁺, especially when in the reaction vessel the concentration of Ag⁺ is greater than or equal to Cu²⁺. At reaction concentrations where Ag⁺ is less than Cu²⁺ this difference diminishes with the decrease of silver ion concentration as expected by the Nernst equation.

Overall, the experimentally-determined composition established a 1:1 relationship between the NP and feeding compositions, demonstrating that the synthesis itself can be well controlled by the feeding molar ratios of the two metal precursors. Since the NPs were thoroughly washed, by which any presence of monometallic Cu NPs would not have survived due to the propensity of oxidation of Cu back to Cu²⁺ ions, the observed 1:1 relationship in FIG. 1 evidences the presence of Cu in the as-synthesized AgCu NPs.

To determine the nanoparticle morphology, size and surface properties, TEM, DLS and zeta potential measurements were performed for the NPs synthesized with a series of compositions. FIG. 2 shows TEM images of AgCu NPs for (a) Ag NP 14, (b), Ag₈₆Cu_{14 16}, and (c) Ag₅₅Cu₄₅ 18, (d) Ag₂₃Cu₇₇ 20 NPs (Scale Bar: 50 nm) with insets of magnified areas, and the corresponding particle size distributions (e through h; 22,24,26,28). FIG. 2 shows a representative set of TEM images for the as-synthesized AgCu NPs. Ag NPs synthesized under the same conditions were included for comparison (2a; 14), which features an average radius 7.4±2.4 nm (2e; 22). The pure AgNPs also showed very little aggregation. In contrast, AgCu nanoparticles showed the presence of similar-sized NPs and a clear increase in particle size due to the aggregation of the neighboring particles. For example, Ag₈₆Cu₁₄ NPs showed NPs with an average radius of 8.22±3.82 nm and larger NPs reflecting the aggregation of the neighboring particles (2b; 16 and 2f; 24). This tendency of aggregation is clearly increased as the Cu % is increased in the NPs. This is evidenced by the data for Ag₅₅Cu₄₅ NPs (2c; 18 and 2g; 26), which showed NPs an average radius of 9.91±2.53 nm and NPs network due to a much higher degree of aggregation than the samples with higher Ag compositions. Here, the TEM characterization focused on the general morphologies of the NPs.

Considering that the as-synthesized bimetallic NPs are very stable in the solution (no indication of aggregation/precipitation for months for NPs with Ag 50%), the different degree of aggregation for the bimetallic NPs revealed by TEM is believed to reflect that the difference of sintering on the TEM grid at the ambient condition between the bimetallic NPs and the pure silver NPs. It is evident that the bimetallic NPs exhibit a greater tendency of aggregation under room temperature on the surface of carbon film of the TEM grid. The increases in particle size for the bimetallic NPs reflect a surface-mediated Ostwald Ripening process, where the larger AgCu nanoparticles were formed at the expense of smaller particles on the surface of carbon film substrate. Apparently, the surface-mediated Ostwald Ripening process is greatly favored as the Cu % is increased in the NPs. This finding is reminiscent of the surface-mediated Ostwald Ripening of AuCu NPs at room temperature. The significance of this finding is that AgCu NPs serve as a new class of room temperature sinterable nanoparticles for the development of printable nano-inks or nano-pastes. The intriguing RT-sinterable properties are further characterized by the following DLS and zeta potential analysis.

FIG. 3 illustrates several graphs showing Dynamic Light Scattering plots of AgCu NPs with different compositions, Zeta potential plots of the same set of AgCu NPs. Ag₉₅Cu₀₅ (a), Ag₈₆Cu₁₄ (b), Ag₅₅Cu₄₅ (c), Ag₂₃Cu₇₇ (d). FIG. 3 shows a graph 30 or representative set of DLS plots for the as-synthesized AgCu NPs, along with a graph 32 the corresponding zeta potentials. The hydrodynamic particle size and size distribution are shown to increase with Cu % in the NPs (Graph 30), indicative of the high propensity aggregation or agglomeration for the high-Cu nanoparticles in the solution. The corresponding zeta potentials of the AgCu NPs are negative (Graph 32), indicative of negative charges on the surface of NPs, which is consistent with the citrate being the capping molecules. The charge is shown to decrease with the Cu % in the NPs (Graph 32), which explains the high propensity of aggregation or agglomeration for the high-Cu alloy NPs in the solution as observed by the DLS data (Graph 30).

Note that agglomeration of nanoparticles could increase the particle size, which is partially responsible for sintering via interparticle coalescence or interparticle necking at room temperature. However, a simple agglomeration process could involve a reversible aggregative process which does not lead to interparticle coalescence or interparticle necking. As shown by the DLS data, the increase of hydrodynamic diameters reflects mostly such a simple agglomeration.

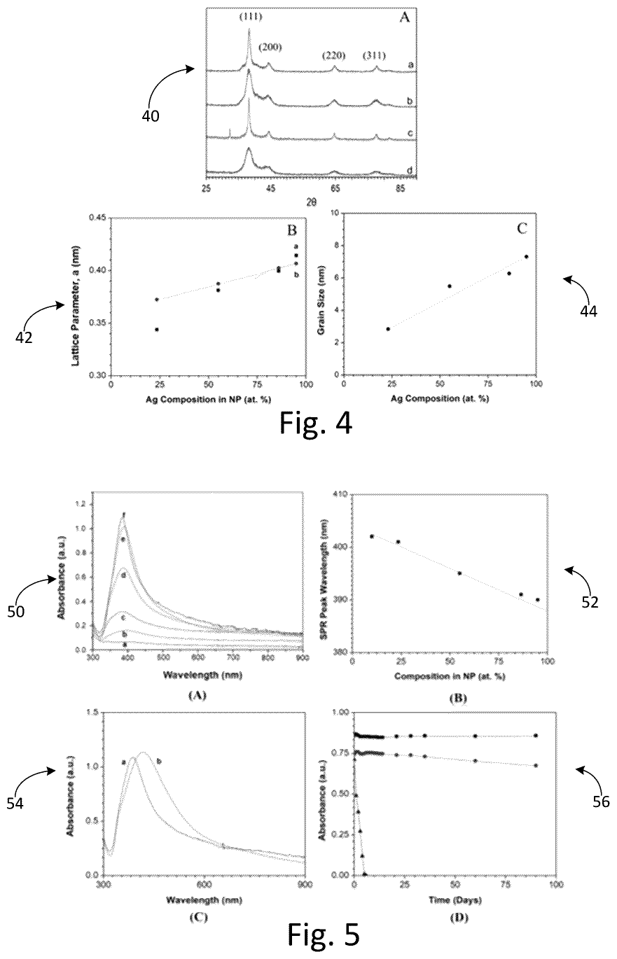

The AgCu NPs of different compositions were further characterized by x-ray diffraction to determine the phase structures and the grain sizes of the NPs. FIG. 4 illustrates graph 40 (A) of XRD patterns for AgCu NPs with different compositions: (a) Ag₉₅Cu₅ (b) Ag₈₆Cu₁₄ (c) Ag₅₅Cu₄₅, and (d) Ag₂₃Cu₇₇. (Note that the peak at 2θ=29° in (c) was due to the sample holder). Graph 42 is a plot of a lattice parameter based on XRD characterization for AgCu NPs (a) in comparison with calculated values from Vegard's Law (b). Graph 44 is a plot of average grain size based on XRD data of AgCu NPs vs. the composition.

Further in FIG. 4, graph 40 (A) shows a representative set of XRD patterns. The peak positions fall in between Ag and Cu, indicating that the AgCu NPs feature a fcc nanoalloy characteristic, not a core shell type structure. This is evidenced by examination of (111) peak, showing no evidence of phase segregation that would be present in a core-shell structure. This is consistent with the lattice shrinking as the Cu % in NPs increases. For example, Ag₅₅Cu₄₅ NPs show a single (111) peak, which corresponds to a lattice parameter falling in between the lattice parameter for Ag (0.409 nm) and that for Cu(0.363 nm). For NPs with Ag %>75%, the observation of a separate small (111) shoulder peak (2θ=37) may be attributed to the presence of a small degree of phase segregation for a different composition.

Based on the XRD data, the lattice parameters of the AgCu NPs of different compositions were obtained (graph 42) showing that the lattice parameter increases with composition of Ag in the NPs. This trend is consistent with that from Vegard's Law:

$${LP}_{alloy} = {xLP}_{Ag} + ( 1 - x ) {LP}_{Cu}$$

where LP_{Ag} and LP_{Cu} are the lattice parameters of pure metals and x is fraction of the components. Subtle differences are evident between the experimental and theoretical values. The good agreement with Vegard's Law in terms of the fcc alloy's lattice parameter versus. The bimetallic composition is evidence of the presence of Cu in the as-synthesized AgCu NPs. This result also suggests the presence of additional lattice strain for the NPs with a higher Cu %, which likely reflects the nanoscale effect on the lattice strain.

The average grain size was determined through the Scherrer equation:

$$τ = \frac{k λ}{β cos cos ( θ )} ,$$

where τ is the mean particle grain size, K is the shape factor, λ is the x-ray wavelength, β is the line broadening at FWHM, and e is the Bragg angle. The average grain size shows a clear trend of increase with the Ag % composition in the NPs (Graph 44). This further supports the tendency of sintering for the bimetallic NPs. The average grain size on average was slightly different than the particle size determined through TEM, reflecting the difference in NP aggregation of the NP samples.

Silver and copper nanoparticles in solutions exhibit strong localized surface plasmon resonance (LSPR) bands due to oscillations of surface conduction electron under the electromagnetic field. These oscillations coincide with specific wavelengths of incident light, which can be identified through UV-Vis. The SPR for Ag NPs occurs at a wavelength of 386 nm, while Cu nanoparticles have an expected wavelength of 548 nm. The characterization of the LSPR bands provides information for assessing the composition change and stability of NPs. FIG. 5 illustrates graphs of UV-Vis spectra for AgCu NPs with different compositions. Graph 50 (A) is for UV-Vis spectra for solution samples of NPs: Ag₁₀Cu₉₀ (a), Ag₂₃Cu₇₇ (b), Ag₅₅Cu₄₅ (c), Ag₈₆Cu₁₄ (d), Ag₉₅Cu₅ (e), and Ag (f) (150 μL samples diluted in 3 mL water). Graph 52 (B) Plot of LSPR band position vs. the Ag composition in the AgCu NPs, (Linear regression: y=−0.163x+404.2). Graph 54 (C) illustrates UV-Vis spectra comparing the Ag₈₆Cu₁₄ NPs synthesized under nitrogen (a) and ambient air (b) atmosphere. Graph 56(D) illustrates a plot of SPR band absorbance at 400 nm vs. time, showing the long-term for AgCu NPs for Ag₈₆Cu₁₄ (a), Ag₅₅Cu₄₅ (b), and Ag₂₃Cu₇₇ (c) under sealed conditions over a 100-day period.

Graph 50 shows a representative set of UV-Vis spectra for AgCu NPs with different compositions. First, the intensity LSPR band is shown to decrease with Cu % in the NPs (Graph 50). Second, the LSPR band is shown to display a subtle red shift to longer wavelength, along with the broadening of the band to the longer wavelength (Graph 52). The red shift also depends on other factors, including a change in the refractive index, particle size, or aggregation. The peak shift reflects a combination of the particle size, size distribution and metal composition of the AgCu NPs. While there is no apparent redshift of the peak position toward the copper LSPR band with the increase of Cu %, there is a peak broadening at the longer wavelength range, indicative of the incorporation of copper in the NPs. DLS data showed an increase in size as the Cu % in the NPs is increased, likely reflecting the increase in aggregation.

It is evident that increasing the composition of Ag in the bimetallic NPs produced a stronger and sharper absorbance peak at the Ag SPR. This is consistent with the fact that Ag has the strongest SPR band among the coinage metals. As Cu % is increased, the band width widened, and the absorbance decreased. The linear trend of SPR band with the composition (Graph 52) supports the bimetallic properties of the AgCu NPs with controllable bimetallic compositions. Simulation of the LSPR bands of pure AgNPs and pure CuNPs were also performed using Mie theory for comparison with the experimental UV-Vis. The simulated LSPR bands for AgNPs and CuNPs occur at 386 nm and Cu at 548 nm, respectively. The LSPR band for pure AgNPs shows a sharp and well-defined peak while CuNPs had a much broader SPR.

The stability of AgCu NPs in solutions was also characterized by monitoring the change of SPR band. Graph 54(C) compares the SPR of the 1× Ag₈₆Cu₁₄ NPs in solutions between the inert and ambient conditions. The solutions were prepared under nitrogen conditions of a Schlenk line to prevent any Cu oxidation and subsequent CuO formation. In comparison, the NPs in ambient atmosphere conditions showed a subtle red shift in the width and SPR position. There are two possibilities for the shift. One possibility is the oxidation of the Cu in the NPs due to exposure to O₂. However, there is little change in the peak intensity which does not seem to support oxidation. It is likely that the NPs under air caused a certain degree of aggregation due to propensity of the surface Cu to undergo partial oxidation and desorption of the capping ligands. This possibility is supported by the observation of aggregation for the NPs synthesized under ambient conditions, which showed a higher degree of aggregation.

The long-term stability of the AgCu NPs was monitored by UV-Vis over a span of ˜100 days for AgCu NPs of three different compositions, as shown in Graph 54(D). Each cuvette was kept under N₂ at room temperature. The NPs with a higher Ag % showed much stronger stability than the other NPs. The NPs with higher Ag % are suspendable in the solution apparently due to suppressed formation of CuO, whereas the Cu-rich particles showed a tendency of precipitation due to formation of CuO. The corresponding DLS and Zeta potential data for Ag₈₆Cu₁₄ and Ag₅₅Cu₄₅ NPs in the solutions after >100 days showed relatively little change to the particle size. The slight shift to smaller particle sizes and slightly broader distribution of zeta potential is due to subtle differences in batch-to-batch synthesis. The slightly broader distribution of zeta potentials is due to the different synthesis batches.

AgCu NPs were formulated into aqueous solution as nanoinks or pastes with a weight percentage of 25% metal NPs and printed onto paper substrates to allow sintering under two different ambient conditions: (1) ambient atmosphere (22° C., ˜18 RH %), and (2) controlled relative humidity (22° C., 1˜90 RH %). The sheet resistance (Ω/□) was measured using a 4-probe multimeter with 2.0-mm probe spacing. A commercial silver ink/paste was also tested for comparison. Table 1 shows a representative set of results for the sheet resistance values determined after drying the traces printed on the paper substrates under ambient condition (room temperature).

TABLE 1
Comparison of sheet resistances for AgCu NPs after sintering
on photopaper substrates at room temperature(22.5° C.).

| | Sheet | |
|---|---|---|
| | Resistance | Sintering |
| Composition | (Ω/□) | Time (hours) |
| Ag (commercially | 19.50 | 22.0 |
| available) | | |
| Ag₁₀₀ | 1.06 | 0.55 |
| Ag₈₆Cu₁₄ | 0.17 | 0.25 |
| Ag₅₅Cu₄₅ | 2.40 | 0.45 |
| Ag₂₃Cu₇₇ | 1207.60 | 1.00 |

For the 25% by weight Ag₈₆Cu₁₄ and Ag₅₅Cu₄₅ inks, the sheet resistances are much lower than that from the 100% commercial silver ink by a factor of 110 and 8, respectively. For Ag₂₃Cu₇₇ nanoink, however, the sheet resistance is greater than that of the commercial silver ink by a factor of 60 and is much greater than the AgCu inks with >50% Ag by 2˜4 of orders of magnitude. The electrical conductivity strongly depends on the bimetallic composition. Using the AgCu nano paste, conductive tracers and interdigitated devices were printed on paper substrates by screen printing.

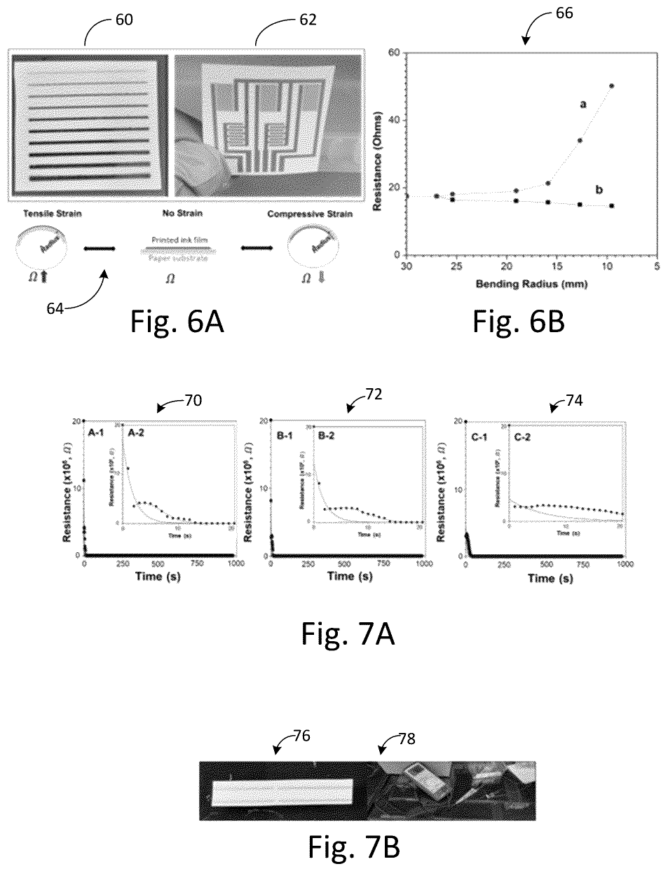

FIG. 6A are pictures of conductive traces 60 and interdigitated electrode arrays 62 on photopaper substrate by screen printing of Ag₅₅Cu₄₅ nanoink, with an illustration of a device strain test with tensile and compressive strains. FIG. 6B is a graph 66 of the results of a strain test of a 33 mm×2 mm photopaper strip printed with a conductive Ag₅₅Cu₄₅ trace upon tensile (a) and compressive strain (b).

FIG. 6A shows a representative set of traces (picture 62) and interdigitated electrode devices (picture 64) on photopaper substrate prepared by screen printing of Ag₅₅Cu₄₅ ink. Each of the printed traces or electrodes is electrically conductive (Table 1) and shows a continuous morphology. The room-temperature sintering behavior depends on both the particle size and the binding strength of the capping agent. Based on the analysis of the transient results from the resistance measurements, the irreversible transition to low resistance values indicates the occurrence of NPs sintering. Also, based on XRD comparison between the NPs and the sintered film, the sintered film showed a much larger grain size, indicative of sintering, and a decrease in the lattice parameter, indicative of a higher degree of alloying after sintering.

The printed AgCu alloy traces (picture 60) on the paper substrate, after the ambient sintering, were further examined to assess the device performance upon bending of the paper substrate (illustrative diagram 64). FIG. 6B shows a graph 66 of the representative set of data on the changes of resistance of a 33-mm conductive trace as a function of trace strain in terms of the bending radius of curvature. For tensile strain (a) (convex), the resistance shows a gradual increase with the reduction of radius of curvature. In contrast, little change was observed for the compressive strain (b) (concave) versus the radius of curvature. This characteristic is desired for the design of a strain sensor.

The room-temperature sintering kinetics were also examined by monitoring the resistance of the conductive traces and the interdigitated microelectrodes (IMEs) on the paper substrate immediately following the screen printing using a stainless steel 325-micron mesh under ambient condition. FIG. 7A illustrates graphs of transient changes of the resistances measured following printing Ag₅₅Cu₄₅ (25% by weight) nanoink on the gap area defined by a silver trace on a HP Photo Paper under ambient condition. FIG. 7B illustrates photos showing the photopaper substrate 76 with conductive-silver traces with a 2-mm gap, and the electrical measurement setup 78.

The results shown in FIG. 7A were measured by printing Ag₅₅Cu₄₅ (25% wt) nanoink across the 2-mm-gap area defined by a silver trace on a paper substrate under ambient condition and monitoring the change of resistance of nanoink in the sintering process (FIG. 7B)). Ag₅₅Cu₄₅ (30% by weight) conductive ink was used in this experiment. Three runs were performed, with Run 1 (graph 70) and Run 2 (graph 72) for 0.50 μL of nanoink being dispensed across the 2-mm gap silver trace (R=0.6 Ω), and Run 3 (graph 74) for 0.75 μL nanoink being dispensed.

For the data with the lower volume of nanoink, the resistance showed a drastic decrease within 50 seconds down to between 2.00-3.50 Ω. For the run with the higher volume of nanoink, it took nearly 100 seconds for the resistance to drastically reduce to a value of 2.000. The change of the resistance (R) can be fitted with a first order rate kinetic model:

$$R = {R}_{1} + {R}_{2} {e}^{- k t}$$

where R₁ and R₂ represent final and initial resistances, respectively, and k is the rate constant for the overall sintering process.

There are two competing processes in sintering. The first is the dominant exponential decay as fitted by the first order kinetic model (eqn. 3). The rate constant k clearly depends on the amount of ink applied to the substrate (0.53 and 0.55 s⁻¹ for 0.5 μL, and 0.17 s⁻¹ for 0.75 μL), with the larger quantity showing a smaller rate constant. The average rate constant (k) is 0.54 s⁻¹. The average final resistance (R₁) is 3.7 Ω, and average initial resistance (R₂) is 1.5×10⁷ Ω. This process is believed to reflect the aggregation NPs during the initial drying process which is accompanied by the growth of the NPs via Ostwald ripening in the surface-mediated sintering process. The second is a process involving an initial resistance increase followed by resistance decrease, which likely reflects a combination of nucleation and growth processes involved in the Ostwald ripening process. For simplicity, we approximate the reaction times by a simple Gaussian distribution in terms of times:

$$R = {C}_{1} \times {e}^{- 0.5 \times {( \frac{t - {t}_{0}}{{C}_{2}} )}^{2}}$$

where C₁ represents the peak height (maximum resistance) and C₂ corresponds to half width of the peak at about 60% of the peak height; and to represents the peak position (the time taken to reach the maximum resistance). The fitting parameters with these two kinetic equations (eqns. 3 and 4) are shown below in Table 2.

TABLE 2
Fitting results from fitting the transient changes of the resistances in FIG. 7.
Fitting Parameters

| eqn. 3 | | | | eqn. 4 | | | |
|---|---|---|---|---|---|---|---|
| Volume of Ink (μL) | R₁ (Ω) | R₂ (Ω) | k (s⁻¹) | Volume of Ink (μL) | C₁ (Ω) | C₂ (s) | t₀ (s) |
| 0.50 | 4.2 | 1.7 × 10⁷ | 0.55 | 0.50 | 4.2 × 10⁶ | 3.70 | 3.40 |
| 0.50 | 3.1 | 1.2 × 10⁷ | 0.53 | 0.50 | 2.7 × 10⁶ | 5.10 | 4.60 |
| 0.75 | 3.4 | 4.6 × 10⁷ | 0.17 | 0.75 | 3.1 × 10⁶ | 6.70 | 11.0 |

The average peaking time (to) is 4 s, with an average half-width of the time distribution of 4.4 s. The average maximum peak resistance is 3.45×10⁶ Ω. The values of the fitting parameters strongly depend on the volume of the nanoink dispensed on the substrates. When more ink is deposited on the substrate the kinetics follow a slower process, reflecting the dissolution of small particles via Ostwald ripening, which is reminiscent of the observation of the resistance peaking for AuCu NP sintering process. In the sintering process, there is a transition from the not-fully-continuous film (less conductive state) of the sintered domains to a continuous film with the interconnected NPs (more conductive state).

The thickness of the nanoink-printed trace was also controlled by controlling the amount of nanoink deposited on the paper substrate. Measured sheet resistance strongly depends on the thickness of the nanoink-printed trace, which was controlled by dispensing 0.5 μL of Ag₈₆Cu₁₄ (30 wt %) to produce a 1-cm trace in successive layers. The thickness of the traces ranged from 10 to 48 μm. The resistivity of the traces decreases with the thickness, indicating likely the important role of interparticle sintering in addition to surface-mediated sintering. Additional paper substrates were also tested with this nanoink, including cellulose nanofibrous substrates, standard 8G letter paper, and Whatman filter paper (#1), the sintered film on the HP paper showed the lowest resistance. However, a detailed assessment of the substrate dependence remains to be studied in future work.

Given the operation of both interparticle sintering and surface-mediated sintering in the ambient sintering process, we further monitored the sintering process under controlled relative humidity. This experiment is performed by printing a nanoink onto a screen-printed silver IME which is then sintered under ambient conditions. This device is then exposed in a chamber with a controlled humidity at room temperature and concurrent measurement of the resistance.

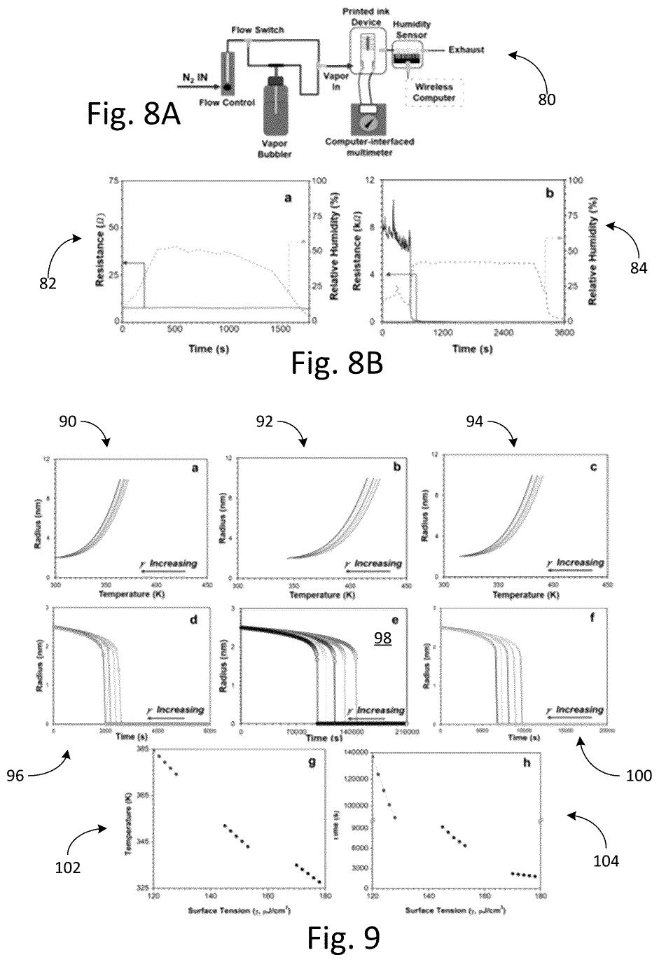

FIG. 8A is an illustrative diagram of an instrument scheme illustrating a measurement setup 80. FIG. 8B illustrates graphs of transient curves showing the changes of resistance of the nanoink-printed IME device with the film of Ag₅₅Cu₄₅ (30% by weight), and (b) Ag₅₅Cu₄₅-HEC (30%-30% by weight). FIG. 8 shows a representative set of transient changes of the resistance values of the AgCu nanoinks under the controlled relative humidity. With a nanoink of Ag₅₅Cu₄₅ (30% by weight) printed on screen-printed silver IME, upon drying under ambient conditions, the film has a very low 2-probe resistance value (8 Ω). This film shows no change upon exposure to 50% RH (FIG. 8B, graph 82)), indicating no effect of water vapor effect on the fully-sintered film.

In contrast, with a nanoink of Ag₅₅Cu₄₅-HydroxyEthyl Cellulose (HEC) (30%-30% by weight) printed on screen-printed silver IME, upon drying under ambient condition, the film has a high 2-probe resistance value (7.00 MΩ) and shows a remarkable reduction of the resistance upon exposing to a controlled humidity of 40% RH at room temperature (FIG. 8B, graph 84). Upon exposure to 40% RH, the resistance shows a rapid decrease from 7 MΩ to a value of 6.81 Ω. This value remains upon switching from the 40% RH to 2% RH under N₂. When successive cycles between 40% RH and 2% RH for 2000 seconds, the resistance is stabilized at 9.11 Ω. This demonstrates water vapor induced sintering of AgCu NPs with cellulose additive in the nanoink at room temperature. Note that sintering is an irreversible process. When there is no sintering, a reversible change in resistance would signify a change in interparticle distance only. When sintering occurs, the change is irreversible. In the presence of HEC in the ink formulation, NPs could not fully sinter initially, but the water effectively dilutes the concentration of HEC in the NP film and changes the surface tension, leading to an effective sintering.

There can be humidity-regulated sintering of AgCu nanoinks with different formulations on IME devices, including bimetallic compositions and cellulose additives (Ag₈₆Cu₁₄, Ag₈₆Cu₁₄-HEC, Ag₂₃Cu₇₇, and Ag₂₃Cu₇₇-HEC). For Ag₈₆Cu₁₄, initial low resistance of the film is indicative of being fully sintered on the substrate before the water vapor treatment is introduced. Upon exposure to water vapor, there is no response in the resistance. For Ag₈₆Cu₁₄-HEC (30% by weight: 30% by weight), there is also no response to humidity, indicative of a film that is already sintered, which is in stark contrast to the Ag₅₅Cu₄₅ HEC (30% by weight: 30% by weight) conductive films. The Ag₈₆Cu₁₄ alloy ink with and without HEC are capable of room temperature sintering without presence of water vapor. For Ag₂₃Cu₇₇, there is a dramatic negative response to the increase of humidity, in sharp contrast to the Ag₈₆Cu₁₄ film. As the humidity increases, the resistance reduces by 4 orders of magnitude, and returns to the original high resistance upon purging with nitrogen. For Ag₂₃Cu₇₇ HEC (30% by weight: 30% by weight), there is also a dramatic negative response to the increase of humidity, similar to that of the Ag₅₅Cu₄₅ film. The un-sintered Ag₂₃Cu₇₇ NPs in a dry state did not undergo sintering even in the presence of water vapor. Instead, it underwent reversible changes in interparticle distances and dielectric medium properties, where HEC additive regulates the adsorption of water vapor in the film.

Based on the recent theoretical simulations on sintering of Ag and Cu NPs, nanoscale Ag and Cu NPs were shown to undergo near room temperature sintering toward bulk conductivity. The adsorption energies of Ag or Cu atom on the surface, where E_{Ag or Cu}, E_{cellulous surface}, and E_{atom/metal surface} are the total energy for the isolated Ag or Cu atom, the isolated substrate (e.g., cellulose), and the Ag or Cu atom adsorption on metal surfaces, respectively. The activation energy of diffusion (E_{diff}) is the barrier of the diffusion that was calculated by ΔEₐ=E_{TS}−E_{IS}, where the energies of the transition state (E_{TS}) and the initial state (E_{IS}) were obtained with ZPE corrections. Theoretical simulations of the sintering processes were carried out in terms of the surface-mediated Ostwald ripening using Gibbs-Thompson (GT) model coupled with modified bond additivity (MBA) model by considering the atom mobilities of the different metals on the surface:

$$\frac{dR}{dt} = \frac{K}{R} ( {e}^{\frac{- {E}_{tot}}{kT}} ) ( {e}^{\frac{2 γΩ}{{kTR}^{*}}} - {e}^{\frac{2 γΩ}{kTR}} )$$

where R is radius of nanoparticle, t is time, Eₜₒₜ is total energy, k is Boltzmann constant, T is temperature, γ is surface free energy, and Ω is atomic volume of bulk metal. R* represents the critical nanoparticle size at which the size neither increases or decreases. K is expressed as K=(2 sin θ)Vₚ Ω/a(2−3 cos θ+ (cos θ)³), where θ is the contact angle, a is an interatomic distance and Vₚ is the frequency of thermal vibration of atoms. The total energy (Eₜₒₜ) is expressed as

$${E}_{tot} = ( Δ {H}_{{sub}^{-}} ( {E}_{ads}^{support} - {E}_{diff}^{support} )$$

where ΔH_{sub} is sublimation energy, E_{ads}^{support} is the adsorption energy of metal atom on the substrate surface, and E_{diff}^{support} is the activation energy for the diffusion of metal atom on the substrate surface.

To determine a more accurate total energy we also considered the nanoparticle size effect on the sublimation energy, which is expressed as ΔH_{sub} (R)=ΔH_{sub}^{∞}−2εₛM/ρR, where ΔH_{sub} (R) is the sublimation energy at a specific size, ΔH_{sub}^{∞} is the sublimation energy of bulk solid metal, p is the bulk solid phase density, and M is the molar mass. εₛ is the specific surface energy, expressed as εₛ(R)=(1−2δ/R+A/R²)εₛ, where δ is Tolman length with a value of 0.3˜0.6, A(=2πRL) is area, and εₛ is the specific surface energy of bulk solid. The understanding of the findings is aided by examining how adhesion, mobility and surface free energy of the two types of atoms play a role in the sintering process.

Theoretically, the surface-mediated Ostwald Ripening (OR) based on Gibbs-Thompson model coupled with modified bond additivity (see equations and parameters in Method, including sublimation energy (ΔH_{sub}), adsorption energy (E_{ads}) and activation energy for diffusion (E_{diff}) of metal atom on the surface was shown to provide a good assessment of the sintering process. Using typical values found for bulk metals, the simulated size evolution for Ag and Cu showed no indication of sintering near room temperature.

With the literature-available bulk and nanoscale parameters for Ag and Cu, we simulated sintering kinetics.

TABLE S1

| | Contact | | Ω | a | Eₜₒₜ | | ΔH_{sub} | E_{adhesion} | E_{diffusion} | R* |
|---|---|---|---|---|---|---|---|---|---|---|
| Metal | Angle | Vₚ (s⁻¹) | (nm³) | (nm) | (kJ/mol) | γ (J/nm²) | (kJ/mol) | (kJ/mol) | (kJ/mol) | (nm) |
| Cu | 18 | 4 × 10¹² | 0.0124 | 0.254 | 113.7 | 1.70 × 10⁻¹⁸ | 160 | 68.5 | 22.0 | 0.6 |
| Ag | 18 | 4 × 10¹² | 0.017 | 0.288 | 126.0 | 1.20 × 10⁻¹⁸ | 168 | 66.0 | 24.0 | 0.6 |
| AgCu | 18 | 4 × 10¹² | 0.0172 | 0.288 | 119.9 | 1.45 × 10⁻¹⁸ | 164 | 67.3 | 23.1 | 0.6 |

Key parameters used for GT MBA-Model based simulation of the NP sintering on the substrate.

With the calculated size-dependent ΔH_{sub}, and cellulose surface mediated E_{ads} and E_{diff}, the surface mediated Eₜₒₜ was considered in the GT-MBA simulation. Eₜₒₜ=300.45 and 290.7 KJ/mol for bulk Ag and Cu, respectively. FIG. 9 illustrates graphs of simulation results based on GT-Model for the sintering processes of Cu, Ag, and AgCu NPs

Further, FIG. 9 illustrates the simulation results based on GT-Model for the sintering processes of Cu, Ag, and AgCu NPs. (a-c): the temperature dependence of the growth of the larger nanoparticles for (graph 90; a) Cu, (graph 92; b) Ag, and AgCu(50:50) graph 94; c) at different surface tensions. The kinetics for the disappearance of the smaller particles for Cu(graph 96; d), Ag (graph 98; e) and AgCu(50:50) (graph 100; f) at different surface tensions (Cu: 140, 142, 144, 146, 148 μJ/cm², Ag: 120, 122, 124, 126, 128 μJ/cm², AgCu: 145, 147, 149, 151, 153 μJ/cm². Plots of the temperature corresponding to the grown large particles at 1 nm vs. surface tension (data from d-f) (graph 102; g), and the time corresponding to the disappearing small particles at 0.5 nm vs. surface tension increases (data from a-c) (graph 104; h).

FIG. 9. graphs 90,92 and 96,98 show a set of simulation results for Cu, Ag, in terms of the time for the temperature dependence of the growth of the large particles and the kinetics for the disappearance of small particles. With the typical values of surface tension 140 μJ/cm² for Cu and 120 μJ/cm² for Ag, the results show that the growth of Cu and Ag particles occur at the temperatures very close to room temperature. The sintering temperature for Cu is much lower than that for Ag. The higher surface free energy and lower sublimation enthalpy would result in a lower sintering temperature, which is consistent with the findings for AuCu alloy nanoparticles. Also simulated is the sintering process for AgCu(50:50) by assuming average values for some of the sintering parameters, e.g., 145 μJ/cm² for the surface tension (Table S1), and the results are shown in graphs 94,100. The sintering kinetics and temperatures are found to fall in between Cu and Ag.²

Based on Young's equation for surface tensions (γ, surface free energy) vs. contact angle (θ):

$${γ}_{( metal - liquid )} = {γ}_{( metal )} - {γ}_{( liquid )} cos$$

the relative change of the Ag/HEC-solution interfacial surface tension upon adsorption of water in the nanoink film is estimated. Consider that the change of contact angle (θ) for the HEC-containing water layer on Ag NP would fall in between 0˜90 degrees depending on the concentration of HEC. The surface free energy of water is 7.3 μJ/cm². The change of γ_{(Ag-water)} of Ag under water is thus expected to fall in between 0-7.3 (γ_{(Ag-water)}=γ_{(Ag)}−γ_{(water)} cos (θ)). By increasing the surface free energy accordingly for Ag (120, 122, 124, and 126, and 128 μJ/cm²) and Cu(170, 172, 174, 176 and 178 μJ/cm²), the simulations yield the results shown in graphs 102,104. The results indicate, indeed, that the sintering time decreases for the disappearance of smaller Ag and Cu NPs (graphs 90,92) and the sintering temperature decreases for the growth of larger Ag and Cu NPs (96,98). By further considering that the surface free energy of AgCu alloy can be approximated as an average of those of Ag and Cu based on a recent study, i.e., 145 μJ/cm² from the average of 120 and 170 ρJ/cm², the results (graphs 94,100) shows that the disappearance of smaller AgCu NPs (graph 94) and the sintering temperature decreases for the growth of larger AgCu NPs.

The surface free energy changes play an important role in the sintering process, as demonstrated by the GT-Model simulation results. It is likely that the surface free energy of the nanoparticles changes upon adsorption of the water vapor in the nanoink-printed film. The surface free energy of the metal nanoparticles is expected to increase upon adsorption of water containing HEC on the surface. Under the elevated RH % in the atmosphere, the adsorption of water would effectively dilute the concentration of HEC near the particle surface, thus leading to the increase of the surface free energy. This results in a decrease of the sintering time. The sintering temperature is shown to drastically reduce. This offers one likely reason to explain the accelerated sintering of AgCu NPs with hydroxyethyl cellulose additive in the ink formulation upon adsorption of water vapor. The hydrophilic HEC additive facilitates the adsorption of water vapor to increase the surface tension, favoring interparticle necking as a sintering mechanism.

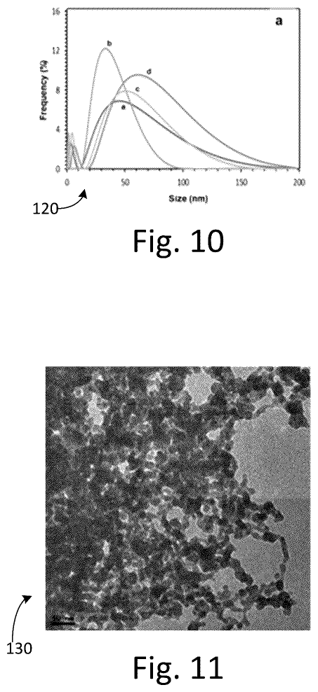

FIG. 10 is a graph 120 of DLS spectra for a solution of Ag₈₆Cu₁₄ nanoparticles. The fresh and aged AgCu NP inks and their room-temperature sintering characteristics were further characterized. The AgCu NPs were dispersed in water without any additives, which allowed extensive studies of the aggregation properties both in water and upon drying. As shown by the dynamical light scattering (DLS) data in FIG. 10, the NPs exhibit a certain degree of aggregation in water, but the fresh and aged samples remain largely similar. This result demonstrates the nanoparticle solutions are very stable in aqueous solutions. In the graph 120, Line (a) is 1-day fresh, Line (b) is 1-year aged (b), and a solution of Ag₅₅Cu₄₅ NPs shown in Line (c) as 1-day fresh and Line (d) 1-year aged.

FIG. 11 is a picture 130 of a transmission electron microscope (TEM) image for an aqueous solution sample of Ag₅₀Cu₅₀ nanoparticles after drying on a carbon film under an ambient condition. As shown by the TEM image in FIG. 11, for a sample after drying under ambient condition, the room-temperature sintering shows clear and highly-networking interconnection of the nanoparticles in large areas, showing large-scale continuity for the sintering of the nanoparticles.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A bimetallic, sinterable AgCu alloy composition, comprising:
AgCu nanoparticles with compositions in a range between Ag₁₀Cu₉₀ and Ag₉₅Cu₅, wherein the AgCu nanoparticles further in a size range between 2 nm to 15 nm; and
ethylene glycol,
wherein the AgCu nanoparticles comprise, at least, 25% by weight of the composition in ink formulation.

2. The composition of claim 1, further including deionized water and ethanol, and wherein the composition further comprised of 30% by weight of AgCu nanoparticles, 30% by weight of ethylene glycol, 30% by weight of deionized water, and 10% by weight of ethanol.

3. The composition of claim 2, wherein the composition comprises a nanoink.

4. The composition of claim 1, further including hydroxyethyl cellulose, and wherein the composition further comprised of 30% by weight of AgCu nanoparticles, 50% of a solution of 5% aqueous hydroxyethyl cellulose, and 20% weight of ethylene glycol.

5. The composition of claim 4, wherein the composition comprises a nanopaste.

6. The composition of claim 1, wherein the AgCu nanoparticles are in a bimetallic composition of Ag₂₃Cu₇₇.

7. A method of making a bimetallic, sinterable AgCu alloy composition, comprising:
providing a container under a constant flow of nitrogen;
purging deionized water in the container with nitrogen for a predetermined duration;
adding copper (II) nitrate trihydrate to the deionized water to form a solution;
adding sodium citrate to the solution;
adding silver nitrate to the solution;
adding sodium borohydride to the solution;
washing the solution in the container with a capping agent;
centrifuging the solution;
decanting the solution; and
resuspending the remaining powder after the decanting in deionized water, the powder comprised of AgCu nanoparticles in a molecular structure in a range between Ag₁₀Cu₉₀ and Ag₉₅Cu₅, wherein the AgCu nanoparticles further in a size range between 2 nm to 15 nm.

8. The method of claim 7, further comprising combining ethylene glycol with the AgCu nanoparticles in deionized water such that the AgCu nanoparticles comprise, at least, 25% by weight of the solution.

9. The method of claim 7, wherein:
adding copper (II) nitrate trihydrate to the deionized water is adding copper (II) nitrate trihydrate at (Cu(NO₃)₂·3H₂O);
adding silver nitrate to the solution is adding silver nitrate at (AgNO₃);
adding sodium borohydride to the solution is adding sodium borohydride powder at (NaBH₄); and
washing the solution in the container with a capping agent is washing the solution with trisodium citrate dihydrate at (Na₃C₆H₅Na₃O₇·2H₂O).

10. The method of claim 9, further comprising creating a nanoink by:
mixing a solution by adding:
30% by weight of AgCu nanoparticles,
30% by weight of ethylene glycol, 30% by weight of deionized water, and
10% by weight of ethanol; and
ultrasonicating the solution in an ice bath for at least 3 cycles of 15 minutes each.

11. The method of claim 9, further comprising creating a nanopaste by:
creating a composition by adding:
30% by weight of AgCu nanoparticles,
50% of a solution of 5% aqueous hydroxyethyl cellulose, and
20% weight of ethylene glycol; and
ultrasonicating the composition for 1 hour-15 minute cycles in an ice water bath.

12. The method of claim 7, wherein the resuspended AgCu nanoparticles are in a molecular structure of Ag₂₃Cu₇₇.

13. The method of claim 9, wherein:
purging deionized water in the container with nitrogen for a predetermined duration is purging 40 mL of deionized water with nitrogen for 10 minutes under stirring at 700 RPM;
adding copper (II) nitrate trihydrate to the deionized water is adding copper (II) nitrate trihydrate at (Cu(NO₃)₂·3H₂O) is adding 0.100 ml of Cu(NO₃)₂ at 1 M to the deionized water;
adding silver nitrate to the solution is adding 0.100 mL of silver nitrate (AgNO₃) at 1 M;
adding sodium borohydride to the solution is adding sodium borohydride at 0.800 mL of NaBH4 (0.25 M) as reducing agent; and
adding trisodium citrate dihydrate is washing the solution with 0.100 mL of trisodium citrate dihydrate at 0.88 M.

14. The method of claim 7, wherein resuspending the remaining powder after the decanting in deionized water a powder comprised of AgCu nanoparticles results in a solution of the AgCu nanoparticles of about 7 nm in diameter.

15. A method of making a printed circuit with an AgCu alloy composition on paper substrates, comprising:
preparing a bimetallic, sinterable AgCu alloy composition comprised of AgCu nanoparticles in a molecular structure in a range between Ag₁₀Cu₉₀ and Ag₉₅Cu₅, wherein the AgCu nanoparticles further in a size range between 2 nm to 15 nm; and
mixing the AgCu alloy composition with, at least, ethylene glycol, wherein the AgCu nanoparticles comprise, at least, 25% by weight of the composition;
depositing the mixture on a paper substrate; and
sintering the deposited mixture at an ambient temperature.

16. The method of claim 15, wherein:
the composition is further comprised of 30% by weight of AgCu nanoparticles, 30% by weight of ethylene glycol, 30% by weight of deionized water, and 10% by weight of ethanol; and
depositing the mixture is printing a nanoink on a paper substrate.

17. The method of claim 15, wherein:
the composition is further comprised of hydroxyethyl cellulose, 30% by weight of AgCu nanoparticles, 50% of a solution of 5% aqueous hydroxyethyl cellulose, and 20% weight of ethylene glycol; and
depositing the mixture is layering a nanopaste on a paper substrate.

18. The method of claim 15, wherein the AgCu nanoparticles are in a composition of Ag₂₃Cu₇₇.

19. The method of claim 15, wherein depositing the mixture is depositing the mixture on the paper substrate at thickness between 10 μm to 48 μm.

20. The method of claim 15, wherein the sintering is water vapor assisted sintering.
